(19) United States
(12) Patent Application Publication
(10) Pub. No.: US 2013/0227333 A1
(43) Pub. Date: Aug. 29, 2013

(54) FAULT MONITORING DEVICE, FAULT MONITORING METHOD, AND NON-TRANSITORY COMPUTER-READABLE RECORDING MEDIUM

(71) Applicant: Fujitsu Limited, (US)

(72) Inventor: Masanobu FURUKOSHI, Kawasaki (JP)

(73) Assignee: Fujitsu Limited, Kawasaki-shi (JP)

(21) Appl. No.: 13/856,008

(22) Filed: Apr. 3, 2013

Related U.S. Application Data
(63) Continuation of application No. PCT/JP2010/068753, filed on Oct. 22, 2010.

(51) Int. Cl. G06F 11/30; G06F 11/07

(52) U.S. Cl. CPC G06F 11/3055; G06F 11/0793
USPC 714/2; 714/47.1

(57) ABSTRACT

A fault monitoring device includes: a controller that is implemented in a computer and controls the computer; a monitored object operated by the computer; a monitor that monitors a fault of the controller and a fault of the monitored object; and a switcher that alternately switches a monitored target by the monitor.

### CROSS-REFERENCE TO RELATED APPLICATION

This application is a continuation application of International Application PCT/JP2010/068753 filed on Oct. 22, 2010 and designated the U.S., the entire contents of which are incorporated herein by reference.

### FIELD

A certain aspect of the embodiments is related to a fault monitoring device, a fault monitoring method, and a non-transitory computer-readable recording medium.

### BACKGROUND

FIG. 1 is a schematic block diagram of a conventional fault monitoring device. In FIG. 1, a fault monitoring device 10 is a blade server based on ATCA (Advanced Telecom Computing Architecture), for example. The ATCA is a hardware specification of a computer for telecommunications carriers. The fault monitoring device 10 monitors faults of an OS (Operating System), an application, a BIOS (Basic Input/Output System) or the like by using a watchdog timer specified by IPMI (Intelligent Platform Management Interface) specification. The fault monitoring device 10 includes a nonvolatile memory 1, a microcomputer 2, a watchdog timer (WDT) controller 3, a watchdog timer (WDT) unit 4, and a monitored object 5.

The microcomputer 2 implements firmware which controls the microcomputer 2 itself. The WDT controller 3 and the WDT unit 4 operate on the firmware. The WDT controller 3 includes: a register 11 that indicates a timer status; a register 12 that indicates pretimeout operation which the firmware performs; and a register 13 that indicates timeout operation which the firmware performs. The WDT controller 3 checks continuation of the operation of the monitored object 5 by using a watchdog timer (WDT) 14 implemented in the WDT unit 4 in order to monitor a fault of the monitored object 5. The WDT unit 4 includes the WDT 14 and a register 15 that indicates beginning and stopping of counting of the WDT14. The monitored object 5 is the OS, the application, the BIOS, or the like.

The WDT controller 3 is connected to the microcomputer 2, the WDT unit 4, and the monitored object 5 via three write/read/reset control lines, respectively. Also, the WDT controller 3 is connected to the WDT unit 4 via an interruption line for pretimeout and an interruption line for timeout. The WDT controller 3 is connected to the monitored object 5 via an interruption line.

A description will be given of the operation of the fault monitoring device 10. FIG. 2 is a sequence diagram illustrating the operation of the fault monitoring device 10 when the monitored object 5 is in a normal state.

First, when the WDT unit 4 boots, the WDT 14 begins countdown (step S1). Here, a maximum value of the WDT 14, a pretimeout value of the WDT 14, pretimeout operation, and timeout operation are set in advance by the monitored object (e.g. the OS). The maximum value of the WDT 14 and the pretimeout value of the WDT 14 are set to the WDT unit 4. A value which specifies the pretimeout operation is set to the register 12. A value which specifies the timeout operation is set to the register 13. Next, the monitored object 5 transmits a reset instruction to the WDT controller 3 at predetermined reset intervals (step S2). The reset interval is predetermined by the monitored object 5, and is a value smaller enough than a value which has subtracted the pretimeout value from the maximum value of the WDT 14. Every time the monitored object 5 receives the reset instruction, the monitored object 5 resets the WDT 14 (step S3). Then, the operation of steps S2 and S3 is repeatedly performed.

FIG. 3 is a sequence diagram illustrating the operation of the fault monitoring device 10 when the monitored object 5 is in an abnormal state (i.e., a fault occurs).

First, when the WDT unit 4 boots, the WDT 14 begins countdown (step S11). The above-mentioned operation of steps S2 and S3 is repeated. When the fault occurs in the monitored object 5, the monitored object 5 cannot transmit the reset instruction of the WDT 14 to the WDT controller 3 at the predetermined reset intervals (step S12).

The WDT unit 4 transmits an interruption command for the pretimeout operation to the WDT controller 3 in response to the WDT 14 having reached the pretimeout value (step S13). The WDT controller 3 receives the interruption command for the pretimeout operation, changes the register 11 indicating the timer status into “pretimeout”, and notifies the firmware in the microcomputer 2 of an interruption command (step S14). The timer status is predetermined with IPMI specification, and has normal, pretimeout, and timeout. When the timer status is the normal, a value “0h” is set to the register 11. When the timer status is the pretimeout, a value “1h” is set to the register 11. When the timer status is the timeout, a value “2h” is set to the register 11.

When the firmware receives the interruption command from the WDT controller 3, the firmware reads out the value of the register 11, reads out the value of the register 12 based on the value read from the register 11, and performs the pretimeout operation depending on the value of the register 12 (step S15). When the value of the register 12 is “00b”, for example, the firmware performs nothing. When the value of the register 12 is “01b”, the firmware waits for timing in which the monitored object 5 can receive an interruption command, and transmits the interruption command to the monitored object 5. When the value of the register 12 is “10b”, the firmware immediately transmits the interruption command to the monitored object 5. When the value of the register 12 is “11b”, the firmware transmits the interruption command to the monitored object 5 when the firmware receives polling from the monitored object 5. The monitored object 5 begins fault recovery operation in response to the interruption command from the firmware. Moreover, the firmware stores a message (SEL event) indicating occurrence of the pretimeout into the nonvolatile memory 1 connected to the microcomputer 2 (step S16).

When the monitored object 5 is not recovered by the fault recovery operation, the countdown of the WDT 14 advances, and the WDT unit 4 transmits an interruption command for the timeout operation to the WDT controller 3 in response to the WDT 14 having reached the timeout value (step S17). The WDT controller 3 receives the interruption command for the timeout operation, changes the register 11 indicating the timer status into the “timeout”, and notifies the firmware in the microcomputer 2 of an interruption command (step S18).

The firmware receives the interruption command from the WDT controller 3, the firmware reads out the value of the register 11, reads out the value of the register 13 based on the value read from the register 11, and performs the timeout operation as the fault recovery operation depending on the value of the register 13 (step S19). When the value of the register 13 is “00b”, for example, the firmware performs nothing. When the value of the register 13 is “01b”, the firmware reboots the monitored object 5 in a state where the fault monitoring device 10 has been turned on. When the value of the register 13 is “10b”, the firmware turns off the fault monitoring device 10. When the value of the register 13 is “11b”, the firmware turns off the fault monitoring device 10, and then turns on the fault monitoring device 10. Moreover, the firmware stores a message (SEL event) indicating occurrence of the timeout into the nonvolatile memory 1 connected to the microcomputer 2 (step S20).

Thus, there has been conventionally known abnormality monitoring device that monitors abnormal operation of the OS and the application by using a watchdog timer (see Japanese Laid-open Patent Publication No. 2009-20545). In addition, there has been conventionally known a method for monitoring boot of plural programs by using plural watchdog timers (see Japanese Laid-open Patent Publication No. 8-30490). In this method, a watchdog timer composed of hardware monitors the boot of one of the programs, and another watchdog timer composed of software monitors the boot of the remaining programs.

### SUMMARY

According to an aspect of the present invention, there is provided a fault monitoring device including: a controller that is implemented in a computer and controls the computer; a monitored object operated by the computer; a monitor that monitors a fault of the controller and a fault of the monitored object; and a switcher that alternately switches a monitored target by the monitor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic block diagram of a conventional fault monitoring device;

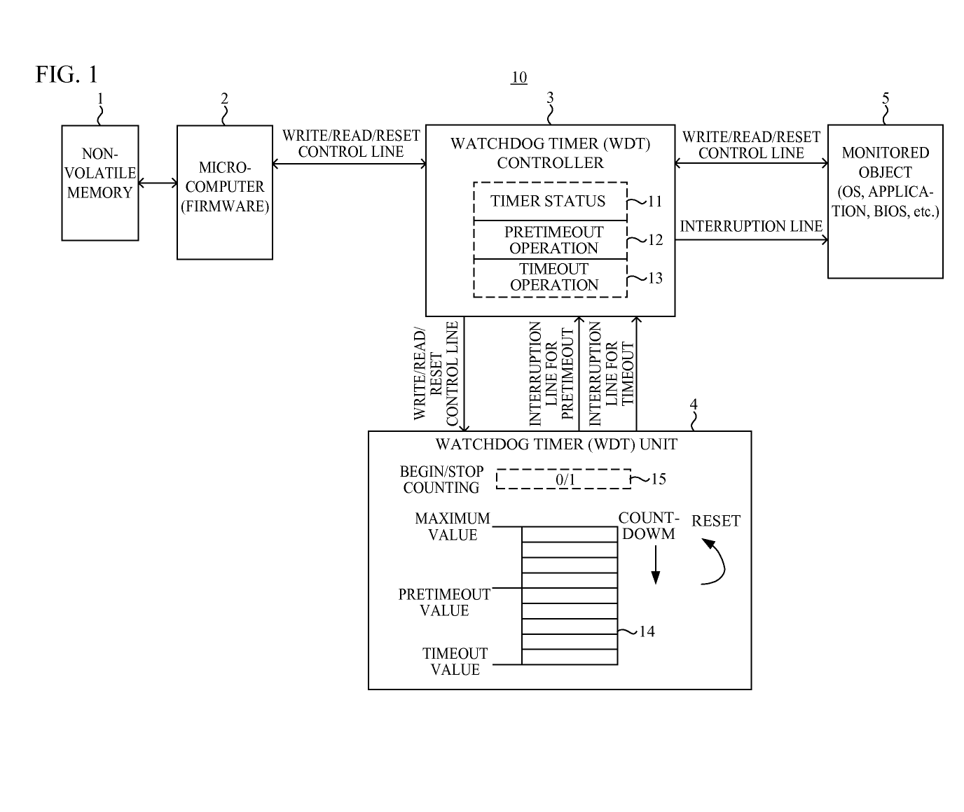

FIG. 2 is a sequence diagram illustrating the operation of a fault monitoring device 10 when a monitored object 5 is in a normal state;

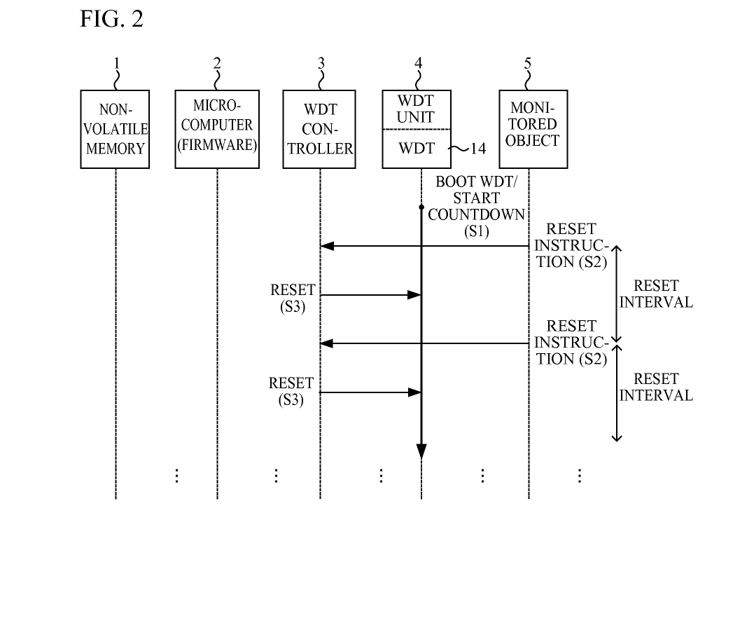

FIG. 3 is a sequence diagram illustrating the operation of the fault monitoring device 10 when the monitored object 5 is in an abnormal state;

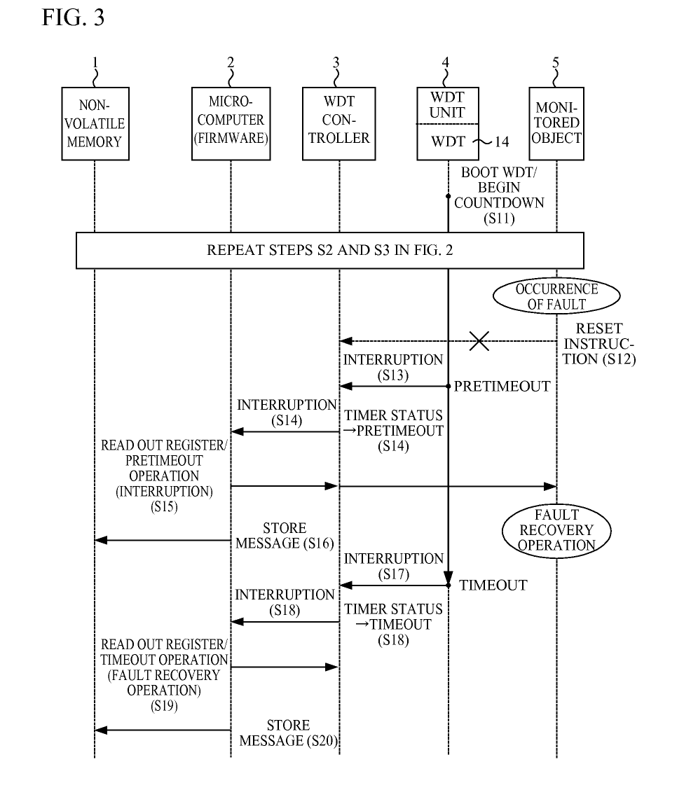

FIG. 4 is a schematic block diagram of a fault monitoring device 100 according to a present embodiment;

FIG. 5 is a schematic block diagram of a register unit 42 in FIG. 4;

FIG. 6 is a sequence diagram illustrating the operation of the fault monitoring device 100 when firmware and a monitored object 35 are in normal states;

FIG. 7 is a sequence diagram illustrating the operation of the fault monitoring device 100 when a fault occurs in the monitored object 35; and

FIG. 8 is a sequence diagram illustrating the operation of the fault monitoring device 100 when a fault occurs in the firmware.

### DESCRIPTION OF EMBODIMENTS

As described above, the fault monitoring device 10 monitors the fault of the monitored object 5. However, when the fault occurs in the firmware, the firmware cannot detect own fault. When the fault occurs in the firmware, the interruption command are not transmitted from the firmware to the monitored object 5, and the monitored object 5 may not perform the fault recovery operation in the time of the pretimeout. In addition, the monitored object 5 cannot detect the fault of the firmware. Therefore, when the fault occurs in the firmware, the fault monitoring device 10 continues operation in the abnormal state (i.e., a state where malfunction can be caused).

A description will be given of embodiments of the invention, with reference to drawings.

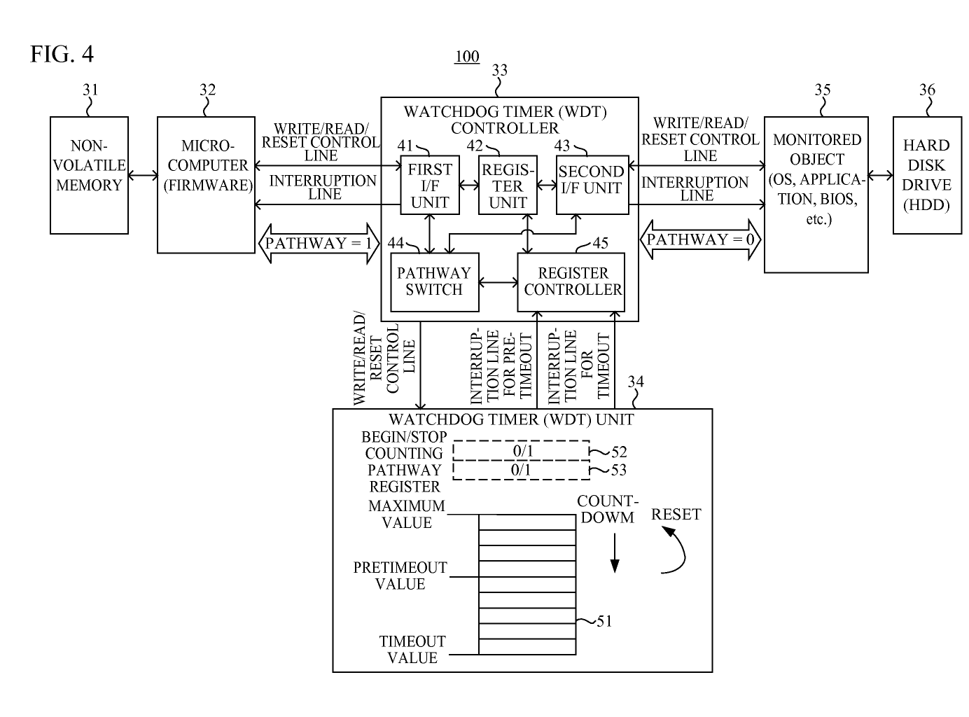

FIG. 4 is a schematic block diagram of a fault monitoring device 100 according to a present embodiment.

In FIG. 4, the fault monitoring device 100 is a blade server based on ATCA (Advanced Telecom Computing Architecture), for example. The ATCA is a hardware specification of a computer for telecommunications carriers. The fault monitoring device 100 monitors faults of firmware, an OS (Operating System), an application, a BIOS (Basic Input/Output System) or the like by using a watchdog timer specified by IPMI (Intelligent Platform Management Interface) specification.

The fault monitoring device 100 includes a nonvolatile memory 31, a microcomputer 32, a watchdog timer (WDT) controller 33, a watchdog timer (WDT) unit 34, a monitored object 35 (i.e., an object to be monitored), and a hard disk drive (HDD) 36. The nonvolatile memory 31 and the HDD 36 serve as recording mediums. The microcomputer 32 as a computer implements firmware which serves as a controller and controls the microcomputer 32 itself. The microcomputer 32 stores a message indicating that pretimeout and timeout has occurred in the monitored object 35, into the nonvolatile memory 31. The WDT controller 33 and the WDT unit 34 operate on the firmware.

The WDT controller 33 includes a first interface (I/F) unit 41, a register unit 42, a second interface (I/F) unit 43, a pathway switch 44, and a register controller 45. The pathway switch 44 and the register controller 45 serve as a switching unit. The first interface unit 41 is connected to the microcomputer 32 via a write/read/reset control line and an interruption line. The first interface (I/F) unit 41 relays access to the WDT unit 34 from the firmware, and relays instructions transmitted and received between the firmware and the monitored object 35. The register unit 42 includes a plurality of registers. A detailed description of these registers is described later. The second interface (I/F) unit 43 is connected to the monitored object 35 via a write/read/reset control line and an interruption line. The second interface (I/F) unit 43 relays access to the WDT unit 34 from the monitored object 35, and relays instructions transmitted and received between the firmware and the monitored object 35.

The pathway switch 44 switches an object accessing the WDT unit 34 to any one of the microcomputer 32 or the monitored object 35, i.e., switches to any one of a pathway from the WDT unit 34 to the microcomputer 32 or a pathway from the WDT unit 34 to the monitored object 35. In an initial state, the object accessing the WDT unit 34 is set to the monitored object 35, for example. The register controller 45 controls switching operation of the pathway switch 44 and reading and writing operation of values in the registers included in the register unit 42. The register controller 45 checks continuation of the operation of the monitored object 35 or the firmware by using a watchdog timer (WDT) 51 implemented in the WDT unit 34 in order to monitor a fault of the monitored object 35 or the firmware.

The WDT unit 34 includes the WDT 51, a register 52 that indicates the beginning and stopping of counting of the WDT 51, and a pathway register 53 that specifies a monitored object. A maximum value, a pretimeout value (a first threshold value), and a timeout value (a second threshold value) of the WDT 51 are set in advance by the monitored object 35. The timeout value of the WDT 51 is a minimum value “0”. When the WDT 51 performs countdown from a maximum value and reaches the pretimeout value, the WDT unit 34 notifies the register controller 45 in the WDT controller 33 of an interruption command via an interruption line for the pretimeout. Moreover, when the WDT 51 reaches the timeout value, the WDT unit 34 notifies the register controller 45 in the WDT controller 33 of an interruption command via an interruption line for the timeout.

When the WDT unit 34 receives a beginning instruction of the countdown from the firmware, the register 52 is set to a value “1” which indicates the beginning of counting of the WDT 51. When the WDT unit 34 receives a stopping instruction of the countdown from the firmware, the register 52 is set to a value “0” which indicates the stopping of counting of the WDT 51. A value “0” or “1” is set to the pathway register 53. When the value of the pathway register 53 is “0”, the WDT 51 performs the countdown to detect occurrence of the fault of the monitored object 35. When the value of the pathway register 53 is “1”, the WDT 51 performs the countdown to detect occurrence of the fault of the firmware.

The monitored object 35 is the OS, the application, or the BIOS. The monitored object 35 stores a message indicating that the pretimeout or timeout has occurred in the firmware into the hard disk drive (HDD) 36.

The WDT controller 33 is connected to the microcomputer 32, the WDT unit 34, and the monitored object 35 via three write/read/reset control lines, respectively. Moreover, the WDT controller 33 is connected to the WDT unit 34 via the interruption line for the pretimeout and the interruption line for the timeout. The WDT controller 33 is connected to the microcomputer 32 and monitored object 35 via two interruption lines.

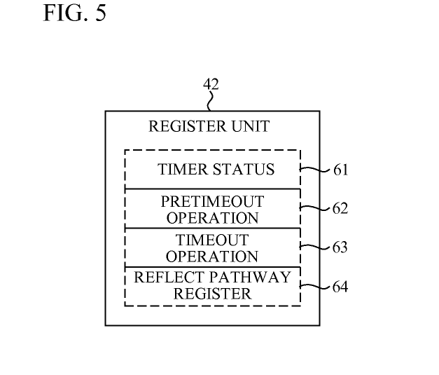

The register unit 42 includes registers 61 to 64, as illustrated in FIG. 5. The register 61 specifies the timer status of the WDT 51. The timer status of the WDT 51 is predetermined with the IPMI specification, and has “normal”, “pretimeout”, and “timeout”, for example. When the WDT 51 is the “normal”, a value “0h” is set to the register 61. When the WDT 51 is the “pretimeout”, a value “1h” is set to the register 61. When the WDT 51 is the “timeout”, a value “2h” is set to the register 61.

The register 62 specifies the pretimeout operation which the firmware or the monitored object 35 performs. The pretimeout operation is operation which the firmware or the monitored object 35 performs when the timer status of the WDT 51 is the “pretimeout”. When a fault occurs in the monitored object 35 and a value of the register 62 is “00b”, for example, the firmware performs nothing. When the fault occurs in the monitored object 35 and the value of the register 62 is “01b”, the firmware waits for timing in which the monitored object 35 can receive an interruption command, and transmits the interruption command to the monitored object 35. When the fault occurs in the monitored object 35 and the value of the register 62 is “10b”, the firmware immediately transmits the interruption command to the monitored object 35. When the fault occurs in the monitored object 35 and a value of the register 62 is “11b”, the firmware transmits the interruption command to the monitored object 35 when the firmware receives polling from the monitored object 35. The monitored object 35 begins fault recovery operation in response to the interruption command from the firmware.

Also when a fault occurs in the firmware and a value of the register 62 is “00b”, for example, the monitored object 35 performs nothing. When the fault occurs in the firmware and the value of the register 62 is “01b”, the monitored object 35 transmits an interruption command for rebooting the firmware without turning off the fault monitoring device 100, to the firmware. When the fault occurs in the firmware and the value of the register 62 is “10b”, the monitored object 35 transmits an interruption command for once turning off the fault monitoring device 100 and rebooting the firmware, to the firmware. The firmware begins fault recovery operation in response to the interruption command from the monitored object 35.

The register 63 specifies the timeout operation which the firmware or the monitored object 35 performs. The timeout operation is operation which the firmware or the monitored object 35 performs when the timer status of the WDT 51 is the “timeout”. When a fault occurs in the monitored object 35 and a value of the register 63 is “00b”, for example, the firmware performs nothing. When the fault occurs in the monitored object 35 and the value of the register 63 is “01b”, the firmware reboots the monitored object 35 in a state where the fault monitoring device 100 is turned on. When the fault occurs in the monitored object 35 and the value of the register 63 is “10b”, the firmware turns off the fault monitoring device 100. When the fault occurs in the monitored object 35 and the value of the register 63 is “11b”, the firmware turns off the fault monitoring device 100, and then turns on the fault monitoring device 100.

Also when a fault occurs in the firmware and a value of the register 63 is “00b”, for example, the monitored object 35 performs nothing. When the fault occurs in the firmware and the value of the register 63 is “01b”, the monitored object 35 reboots the fault monitoring device 100. When the fault occurs in the firmware and the value of the register 63 is “10b”, the monitored object 35 shuts down the fault monitoring device 100.

The register 64 reflects the value of the pathway register 53, i.e., indicates the same value as the value of the pathway register 53. Every time the value of the pathway register 53 is updated, the register controller 45 updates a value of the register 64 depending on the value of the pathway register 53. Moreover, the register controller 45 controls the pathway switch 44 so as to switch a pathway based on the value of the register 64, i.e. , the value of the pathway register 53. For example, when the value of the pathway register 53 is “0”, the register controller 45 controls the pathway switch 44 so as to select a pathway from the WDT unit 34 to the monitored object 35 (hereinafter referred to as “a pathway “0””). When the value of the pathway register 53 is “1”, the register controller 45 controls the pathway switch 44 so as to select a pathway from the WDT unit 34 to the firmware (hereinafter referred to as “a pathway “1””). That is, the pathway switch 44 switches a pathway to be connected to the WDT unit 34, to any one of the pathway “0” or “1” based on the value of the pathway register 53.

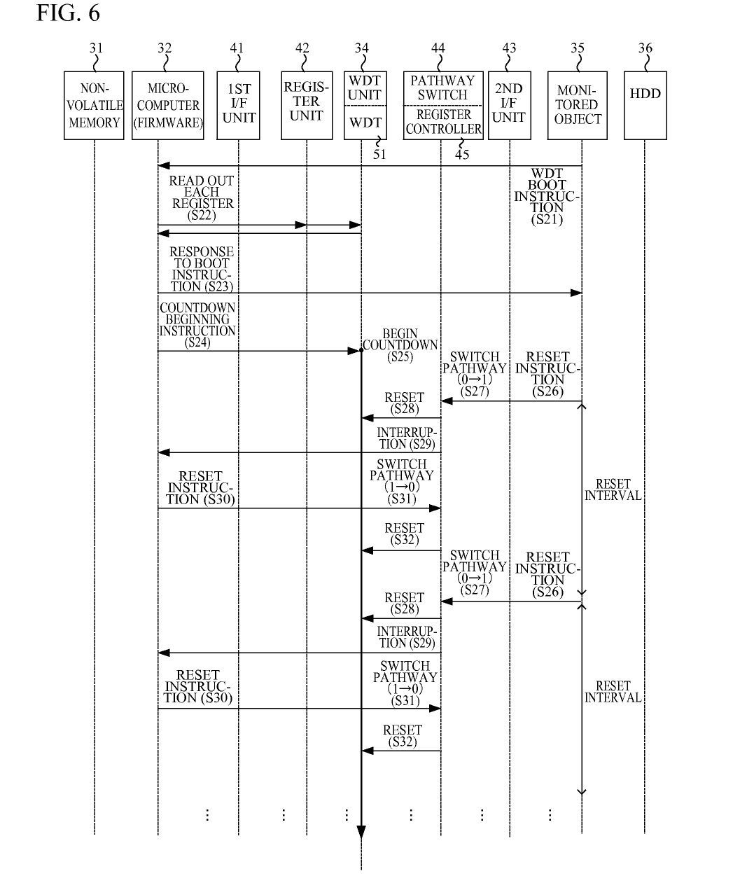

Next, a description will be given of the operation of the fault monitoring device 100. FIG. 6 is a sequence diagram illustrating the operation of the fault monitoring device 100 when the firmware and the monitored object 35 are in normal states.

First, the monitored object 35 notifies the firmware in the microcomputer 32 of a boot instruction of the WDT 51 via the two interruption lines connected to the WDT controller 33 (step S21). The firmware reads out the value of each register stored into the register unit 42 and the WDT unit 34 (step S22). After the value of each register is read out, the firmware sends back a response to the boot instruction of the WDT 51 (e.g. a response indicating the completion of preparation) to the monitored object 35 via the two interruption lines connected to the WDT controller 33 (step S23). Then, the firmware notifies the WDT unit 34 of an instruction indicating beginning of the countdown of the WDT 51 via the WDT controller 33 (step S24).

The WDT 51 begins the countdown in response to the instruction indicating beginning of the countdown (step S25). Here, the maximum value, the pretimeout value, the timeout value, the pretimeout operation, and the timeout operation of the WDT 51 are set in advance by the monitored object 35 (e.g. the OS). The maximum value, the pretimeout value, and the timeout value of the WDT 51 are set to the WDT unit 34. The timeout value of the WDT 51 is a minimum value “0”. A value which specifies the pretimeout operation is set to the register 62. A value which specifies the timeout operation is set to the register 63.

Next, the monitored object 35 transmits a reset instruction of the WDT 51 to the register controller 45 in the WDT controller 33 via the write/read/reset control line, at fixed rest intervals (step S26). The reset interval is predetermined by the monitored object 35, and is a value smaller enough than a value which has subtracted the pretimeout value from the maximum value of the WDT 51.

The register controller 45 in the WDT controller 33 receives the reset instruction of the WDT 51 via the second I/F unit 43 and the register unit 42, inverts the value of the pathway register 53 (0->1), and switches the pathway of the pathway switch 44 (0->1) (step S27). The register controller 45 resets, i.e., initializes the WDT 51 (step S28). The register controller 45 transmits an interruption command to the firmware via the first I/F unit 41, the register unit 42 and the interruption line (step S29).

The firmware sends back the reset instruction of the WDT 51 to the register controller 45 via the write/read/reset control line, in response to the interruption command from the register controller 45 (step S30).

The register controller 45 receives the reset instruction of the WDT 51 via the first I/F unit 41 and the register unit 42, inverts the value of the pathway register 53 (1->0), and switches the pathway of the pathway switch 44 (1->0) (step S31). Moreover, the register controller 45 resets, i.e., initializes the WDT 51 (step S32). When the firmware and the monitored object 35 are in the normal states, the procedures of steps S26 to S32 repeatedly performed.

According to FIG. 6, when the firmware and the monitored object 35 are normal, the register controller 45 alternately repeats first operation that switches a monitored target (i.e. a target to be monitored) from the monitored object 35 to the firmware and resets the WDT 51 depending on the reset instruction received from the monitored object 35, and second operation that switches the monitored target from the firmware to the monitored object 35 and resets the WDT 51 depending on the reset instruction received from the firmware, at fixed intervals. Therefore, the register controller 45 can continue monitoring the firmware and the monitored object 35 alternately by using the single WDT 51. Here, in FIG. 6, a first monitored target is set to the monitored object 35 in advance, but the first monitored target is not limited to this in the present embodiment. For example, the first monitored target may be set to the firmware in advance. In this case, the register controller 45 performs the second operation firstly, and performs the first operation secondly.

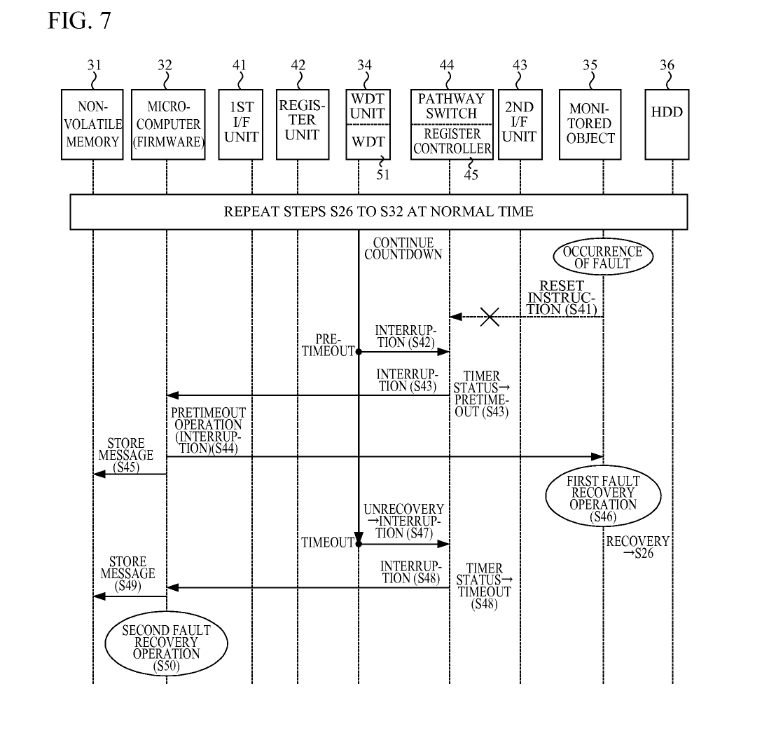

FIG. 7 is a sequence diagram illustrating the operation of the fault monitoring device 100 when the fault occurs in the monitored object 35. Operation which is identical with the operation of FIG. 6 is designated by the same step number, and duplicate description thereof is omitted.

First, when the firmware and the monitored object 35 are in the normal states, the procedures of steps S26 to S32 in FIG. 6 are repeatedly performed.

When the fault occurs in the monitored object 35, the monitored object 35 does not transmit the reset instruction of the WDT 51 to the register controller 45 (step S41). Since the register controller 45 waits for the reset instruction of the WDT 51 from the monitored object 35, the pathway register 53 is in a state of “0” at this time. The pathway switch 44 is in a state where the pathway “0” has been selected.

Then, the countdown of the WDT 51 is continued, and the WDT unit 34 transmits an interruption command for the pretimeout operation to the register controller 45 in response to the WDT 51 having reached the pretimeout value (step S42). The register controller 45 receives the interruption command for the pretimeout operation, changes the register 61 indicating the timer status into the “pretimeout”, and notifies the firmware corresponding to a value (“1”) opposite to the value “0 (the monitored object 35)” indicated by the pathway register 53 of the interruption command for the pretimeout operation (step S43). The interruption command for the pretimeout operation indicates that the fault has occurred in the monitored object 35.

When the firmware receives the interruption command for the pretimeout operation from the register controller 45, the firmware performs the pretimeout operation depending on the value of the register 62 (step S44). The pretimeout operation is decided depending on the value of the register 62 as described above. When the value of the register 62 is “00b”, the firmware performs nothing. When the value of the register 62 is “01b”, “10b” and “11b”, the firmware transmits an interruption command as a recovery request of the fault to the monitored object 35, as the pretimeout operation. Moreover, the firmware stores a message (SEL Event) indicating occurrence of the pretimeout into the nonvolatile memory 31 (step S45). The monitored object 35 begins the first fault recovery operation in response to the interruption command from the firmware (i.e., the recovery request of the fault) (step S46). That is, the monitored object 35 itself performs the fault recovery operation in response to the recovery request of the fault from the firmware. Here, the first fault recovery operation is, for example, retransmission of the reset instruction of the WDT 51 or reboot of the monitored object 35 or the like, and is predetermined by the monitored object 35.

When the monitored object 35 is recovered by the first recovery operation, the procedure returns to step S26 of FIG. 6. When the monitored object 35 is not recovered by the first fault recovery operation, the countdown of the WDT 51 advances, and the WDT unit 34 transmits an interruption command for the timeout operation to the register controller 45 in response to the WDT 51 having reached the timeout value (step S47).

The register controller 45 receives the interruption command for the timeout operation, changes the register 61 indicating the timer status into the “timeout”, and notifies the firmware corresponding to the value (“1”) opposite to the value “0 (the monitored object 35)” indicated by the pathway register 53 of the interruption command for the timeout operation (step S48). The interruption command for the timeout operation indicates that the fault of the monitored object 35 is in an unrecoverable state.

When the firmware receives the interruption command for the timeout operation from the register controller 45, the firmware stores a message (SEL Event) indicating occurrence of the timeout into the nonvolatile memory 31 (step S49). The message indicating occurrence of the pretimeout or timeout is stored into the nonvolatile memory 31, so that an administrator of the fault monitoring system 100 can recognizes that the fault has occurred in the monitored object 35. In addition, the firmware performs the timeout operation depending on the value of the register 63, i.e., the second fault recovery operation (step S50). The timeout operation is decided depending on the value of the register 63, as described above. When the value of the register 63 is “00b”, the firmware performs nothing. When the value of the register 63 is “01b”, the firmware reboots the monitored object 35 in a state where the fault monitoring device 100 is turned on. When the value of the register 63 is “10b”, the firmware turns off the fault monitoring device 100. When the value of the register 63 is “11b”, the firmware turns off the fault monitoring device 100, and then turns on the fault monitoring device 100. That is, when the value of the register 63 is “01b” or “11b”, the firmware which is in the normal state can perform the fault recovery operation of the monitored object 35.

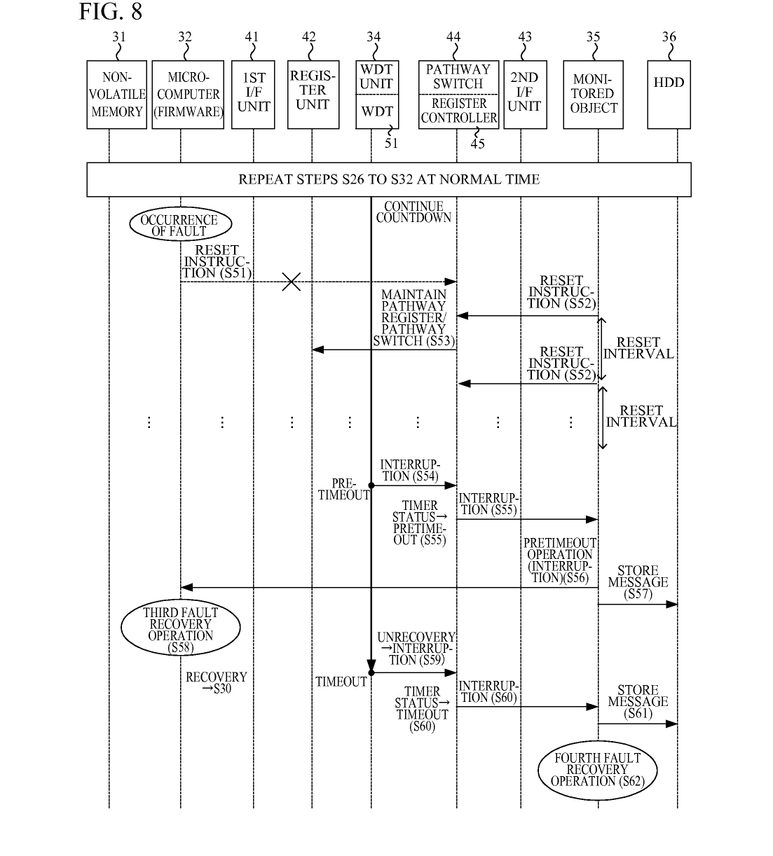

FIG. 8 is a sequence diagram illustrating the operation of the fault monitoring device 100 when the fault occurs in the firmware. Operation which is identical with the operation of FIG. 6 is designated by the same step number, and duplicate description thereof is omitted.

First, when the firmware and the monitored object 35 are in the normal states, the procedures of steps S26 to S32 in FIG. 6 are repeatedly performed.

When the fault occurs in the firmware, the firmware does not transmit the reset instruction of the WDT 51 to the register controller 45 (step S51). Since the firmware cannot respond to an interruption command from the register controller 45, the pathway register 53 is in a state of “1” at this time. The pathway switch 44 is in a state where the pathway “1” has been selected.

On the other hand, the monitored object 35 transmits the reset instruction of the WDT 51 to the register controller 45 via the write/read/reset control line at fixed reset intervals (step S52). The register controller 45 receives the reset instruction of the WDT 51 to the register controller 45 via the second I/F unit 43 and the register unit 42, but maintains the value of the pathway register 53 (1->1), and the pathway of the pathway of the pathway switch 44 (1->1) (step S53). Since the fault occurs in the firmware, the operation of steps S52 and S53 is repeatedly performed. The countdown of the WDT51 is continued.

Then, the WDT unit 34 transmits an interruption command for the pretimeout operation to the register controller 45 in response to the WDT 51 having reached the pretimeout value (step S54). The register controller 45 receives the interruption command for the pretimeout operation, changes the register 61 indicating the timer status into the “pretimeout”, and notifies the monitored object 35 corresponding to a value (“0”) opposite to the value “1 (the firmware)” indicated by the pathway register 53 of the interruption command for the pretimeout operation (step S55). The interruption command for the pretimeout operation indicates that the fault has occurred in the firmware.

When the monitored object 35 receives the interruption command for the pretimeout operation from the register controller 45, the monitored object 35 performs the pretimeout operation depending on the value of the register 62 (step S56). The pretimeout operation is decided depending on the value of the register 62 as described above. For example, when the value of the register 62 is “00b”, the monitored object 35 performs nothing. When the value of the register 62 is “01b”, the monitored object 35 transmits an interruption command for rebooting the firmware without turning off the fault monitoring device 100, to the firmware. When the value of the register 62 is “10b”, the monitored object 35 transmits an interruption command for once turning off the fault monitoring device 100 and rebooting the firmware, to the firmware. Moreover, the monitored object 35 stores a message (SEL Event) indicating occurrence of the pretimeout into the HDD 36 (step S57). The firmware begins third fault recovery operation in response to the interruption command from the monitored object 35 (i.e., a recovery request of the fault) (step S58). That is, the firmware itself performs the fault recovery operation in response to the recovery request of the fault from the monitored object 35. Here, the third fault recovery operation is reboot of the firmware, for example, and is predetermined by the monitored object 35.

When the firmware is recovered by the third fault recovery operation, the procedure returns to step S30 of FIG. 6. When the firmware is not recovered by the third fault recovery operation, the countdown of the WDT 51 advances, and the WDT unit 34 transmits an interruption command for the timeout operation to the register controller 45 in response to the WDT 51 having reached the timeout value (step S59).

The register controller 45 receives the interruption command for the timeout operation, changes the register 61 indicating the timer status into the “timeout”, and notifies the monitored object 35 corresponding to a value (“0”) opposite to the value “1 (the firmware)” indicated by the pathway register 53 of the interruption command for the timeout operation (step S60). The interruption command for the timeout operation indicates that the fault of the firmware is in an unrecoverable state.

When the monitored object 35 receives the interruption command for the timeout operation from the register controller 45, the monitored object 35 stores a message (SEL Event) indicating occurrence of the timeout into the HDD 36 (step S61). The message indicating occurrence of the pretimeout or timeout is stored into the HDD 36, so that the administrator of the fault monitoring system 100 can recognizes that the fault has occurred in the firmware. In addition, the monitored object 35 performs the timeout operation depending on the value of the register 63, i.e., fourth fault recovery operation (step S62). The timeout operation is decided depending on the value of the register 63, as described above. When the value of the register 63 is “00b”, the monitored object 35 performs nothing. When the value of the register 63 is “01b”, the monitored object 35 reboots the fault monitoring device 100. When the value of the register 63 is “10b”, the monitored object 35 shuts down the fault monitoring device 100. That is, when the value of the register 63 is “01b” or “10b”, the monitored object 35 which is in the normal state can perform the fault recovery operation of the firmware.

As described above, according to the present embodiment, the fault monitoring device 100 includes: the WDT 51 that monitors a fault of the firmware controlling the microcomputer 32 or a fault of the monitored object 35 operated by the microcomputer 32; and the pathway switch 44 and the register controller 45 that alternately switch the monitored target by the WDT 51. Therefore, the fault monitoring device 100 can detect occurrence of the faults of the firmware and the monitored object 35 by using the single watchdog timer.

A non-transitory recording medium on which the software program for realizing the functions of the fault monitoring device 100 is recorded may be supplied to the fault monitoring device 100, and the WDT controller 33 may read and execute the program recorded on the non-transitory recording medium. In this manner, the same effects as those of the above-mentioned embodiment can be achieved. The non-transitory recording medium for providing the program may be a CD-ROM (Compact Disk Read Only Memory), a DVD (Digital Versatile Disk), a Blu-ray Disk, SD (Secure Digital) card or the like, for example. Alternatively, the WDT controller 33 may execute a software program for realizing the functions of the fault monitoring device 100, so as to achieve the same effects as those of the above-described embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A fault monitoring device comprising:
a controller that is implemented in a computer and controls the computer;
a monitored object operated by the computer;
a monitor that monitors a fault of the controller and a fault of the monitored object; and
a switcher that alternately switches a monitored target by the monitor.

2. The fault monitoring device as claimed in claim 1, further comprising a watchdog timer that performs countdown;
wherein the switcher alternately repeats first operation and second operation at fixed intervals when the controller and the monitored object are normal, the first operation being operable to switch the monitored target to the controller and reset the watchdog timer depending on an instruction received from the monitored object, and the second operation being operable to switch the monitored target to the monitored object and reset the watchdog timer depending on an instruction received from the controller.

3. The fault monitoring device as claimed in claim 2, wherein when the switcher does not receive a reset instruction of the watchdog timer from any one of the controller and the monitored object, and the watchdog timer is not reset even when the countdown of the watchdog timer reaches a predetermined first threshold value, the switcher notifies any one of the controller and the monitored object of occurrence of the fault in another one of the controller and the monitored object transmitting no reset instruction of the watchdog timer, and
the any one of the controller and the monitored object that is notified of the occurrence of the fault stores information indicating the occurrence of the fault into a recording medium.

4. The fault monitoring device as claimed in claim 3, wherein the any one of the controller and the monitored object that is notified of the occurrence of the fault notifies the another one of the controller and the monitored object in which the fault has occurred of a recovery request of the fault, and the another one of the controller and the monitored object in which the fault has occurred performs recovery operation of the fault.

5. The fault monitoring device as claimed in claim 4, wherein when the fault is not recovered by the recovery operation of the fault, and the watchdog timer is not reset even when the countdown of the watchdog timer reaches a predetermined second threshold value, the switcher notifies the any one of the controller and the monitored object of an unrecoverable state of the fault in the another one of the controller and the monitored object transmitting no reset instruction of the watchdog timer, and
the any one of the controller and the monitored object that is notified of the occurrence of the fault stores information indicating the unrecoverable state of the fault into the recording medium and performs the recovery operation of another fault.

6. A fault monitoring method comprising:
monitoring a fault that occurs in a controller that is implemented in a computer and controls the computer; and a fault that occurs in a monitored object operated by the computer; and
alternately switching a monitored target by the monitoring.

7. A non-transitory computer-readable recording medium having stored therein a program for causing a computer to execute a process, the process comprising:
monitoring a fault that occurs in a controller that is implemented in another computer and controls the computer; and a fault that occurs in a monitored object operated by the computer; and
alternately switching a monitored target by the monitoring.
